(19) United States
(12) Patent Application Publication
(10) Pub. No.: US 2014/0312792 A1
(43) Pub. Date: Oct. 23, 2014

(54) BACKLIGHT DRIVING MODULE

(71) Applicants: Tzu-Chiang Mi, Taipei City (TW); Yi-Hsun Lin, Taipei City (TW); Wei-Chih Shih, Taipei City (TW)

(72) Inventors: Tzu-Chiang Mi, Taipei City (TW); Yi-Hsun Lin, Taipei City (TW); Wei-Chih Shih, Taipei City (TW)

(73) Assignee: COMPAL ELECTRONICS, INC., Taipei City (TW)

(21) Appl. No.: 14/255,962

(22) Filed: Apr. 18, 2014

Related U.S. Application Data
(60) Provisional application No. 61/813,641, filed on Apr. 19, 2013.

(51) Int. Cl. H05B 33/08

(52) U.S. Cl. CPC H05B 33/0842
USPC 315/192

(57) ABSTRACT

A backlight driving module including a power converter module and a processor module is provided. The power converter module is configured to convert a first power to a second power to drive the backlight module according to a driving parameter set. The processor module is configured to provide the first power to the power converter module. One of the processor module and the power converter module determines a configuration of the backlight module by using identification information. The driving parameter set corresponds to the configuration of the backlight module.

### CROSS-REFERENCE TO RELATED APPLICATION

This application claims the priority benefits of U.S. provisional application serial no. 61/813,641, filed on Apr. 19, 2013. The entirety of the above-mentioned patent applications is hereby incorporated by reference herein and made a part of this specification.

### BACKGROUND

1. Technical Field

The disclosure relates to a driving module. Particularly, the disclosure relates to a backlight driving module.

2. Related Art

Generally, a display panel is used in collaboration with a backlight module to provide a backlight source required for displaying images. The backlight module probably has a different configuration in response to an actual design requirement, for example, a different number of light-emitting diode (LED) strings configured on the backlight module, or a different number of LEDs in each of the LED strings. Due to the aforementioned different configurations, the backlight module has to be driven by using different backlight driving modules. Therefore, corresponding to different configurations of the backlight module, the backlight driving module must have a corresponding circuit structure design, which increases a development time and development cost of the backlight driving module. According to the conventional technique, a surface mount technology (SMT) or a digital motion processor (DMP) jumper is generally used to resolve the above problem, though the above solution increases manufacturing cost and management cost of a manufacturer.

### SUMMARY

The disclosure is directed to a backlight driving module, which is capable of simultaneously supporting different backlight module configurations.

The disclosure provides a backlight driving module, which is adapted to a backlight module. The backlight driving module includes a power converter module and a processor module. The power converter module converts a first power to a second power to drive the backlight module according to a driving parameter set. The processor module provides the first power to the power converter module. One of the processor module and the power converter module determines a configuration of the backlight module by using identification information. The driving parameter set corresponds to the configuration of the backlight module.

In an embodiment of the disclosure, the power converter module includes a first connector, and the backlight module includes a second connector. The power converter module is electrically connected to the backlight module through the first connector and the second connector. A part of pins of the first connector are set corresponding to the configuration of the backlight module for providing the identification information.

In an embodiment of the disclosure, the processor module includes a determination unit. The determination unit determines the configuration of the backlight module according to the identification information, so as to select the driving parameter set from a plurality of predetermined driving parameter sets. The predetermined driving parameter sets are stored in the processor module or the power converter module.

In an embodiment of the disclosure, the processor module includes a storage unit. The storage unit is configured to store the predetermined driving parameter sets. The determination unit selects the driving parameter set from the predetermined driving parameter sets stored in the storage unit.

In an embodiment of the disclosure, the power converter module includes a setting unit. The setting unit is configured to at least convert the first power to the second power to drive the backlight module according to the driving parameter set.

In an embodiment of the disclosure, the setting unit includes a register unit. The register unit is configured to temporarily store the identification information. The processor module reads the identification information, and obtains the driving parameter set from the predetermined driving parameter sets stored in the processor module according to the identification information. The setting unit is configured to at least convert the first power to the second power to drive the backlight module according to the driving parameter set.

In an embodiment of the disclosure, the processor module reads the identification information through a system bus.

In an embodiment of the disclosure, the setting unit includes a register unit. The register unit is configured to store a plurality of predetermined driving parameter sets. The setting unit selects the driving parameter set from the predetermined driving parameter sets according to the identification information.

In an embodiment of the disclosure, the power converter module includes a determination unit. The determination unit is configured to determine the configuration of the backlight module according to the identification information. The determination unit includes a logic circuit.

In an embodiment of the disclosure, the logic circuit includes a plurality of switches. Any one of the switches is connected to the backlight module through a driving channel. The identification information is used for controlling a conduction state of the driving channel to generate the driving parameter set to drive the backlight module.

In an embodiment of the disclosure, the power converter module further includes a driving unit. The driving unit is configured to generate the driving parameter set according to a determination result of the determination unit. The driving unit at least converts the first power to the second power to drive the backlight module by using the driving parameter set.

In an embodiment of the disclosure, the power converter module includes a detection unit. The detection unit is configured to detect the configuration of the backlight module for providing the identification information to the processor module.

In an embodiment of the disclosure, the detection unit sends a detection signal to the backlight module, and takes a feedback signal as the identification information, and the processor module generates the driving parameter set according to the identification information.

According to the above descriptions, the backlight driving module of the disclosure selects a driving parameter set from the predetermined driving parameter sets according to a different configuration of the backlight module of the display panel, or self-detects or determines the configuration of the backlight module to generate the driving parameter set, so as to properly drive the backlight module of the display panel, so that different configurations of the backlight module are supported.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a backlight driving module according to an embodiment of the disclosure.

FIG. 2 is a schematic diagram of a backlight driving module according to another embodiment of the disclosure.

FIG. 3 is a schematic diagram of a backlight driving module according to another embodiment of the disclosure.

FIG. 4 is a schematic diagram of a backlight module according to another embodiment of the disclosure.

FIG. 5 is a schematic diagram of a backlight driving module according to another embodiment of the disclosure.

FIG. 6 is a flowchart illustrating steps of a driving method of a backlight module according to an embodiment of the disclosure.

### DETAILED DESCRIPTION OF DISCLOSED EMBODIMENTS

In an exemplary embodiment of the disclosure, a backlight driving module can select a driving parameter set from a plurality of predetermined driving parameter sets according to a different configuration of a backlight module of a display panel, so as to properly drive the backlight module of the display panel. Regarding one of the methods for identifying the configuration of the backlight module, a part of pins of a connector of the backlight driving module can provide identification information, and a processor module or a power converter module can determine the configuration of the backlight module according to the identification information, so as to select the proper driving parameter set. In an embodiment, the backlight driving module can also self-detect or determine the configuration of the backlight module to generate the driving parameter set. A plurality of embodiments are provided below to describe the disclosure in detail, though the disclosure is not limited to the provided embodiments, and the provided embodiments can be suitably combined.

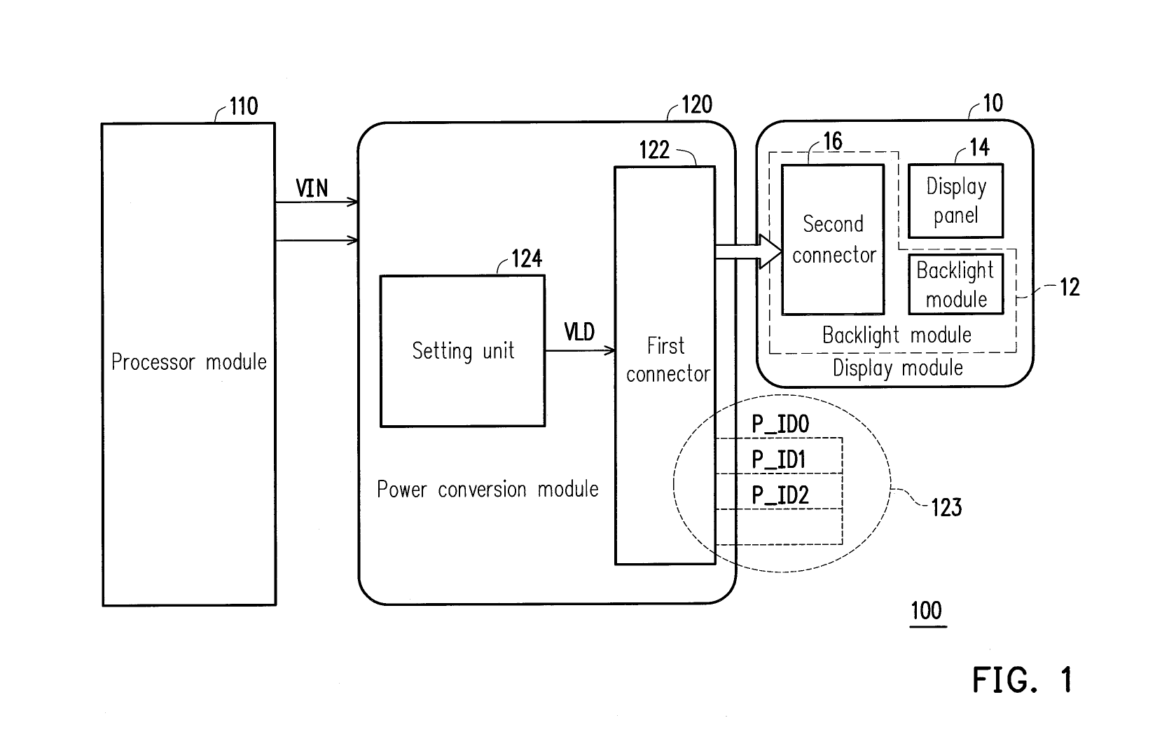

FIG. 1 is a schematic diagram of a backlight driving module according to an embodiment of the disclosure. Referring to FIG. 1, the backlight driving module 100 of the present embodiment includes a processor module 110 and a power converter module 120. The backlight driving module 100 is configured to drive a backlight module 12 of a display module 10, such that the backlight module 12 can provide a backlight source required by a display panel 14 for displaying images. In the present embodiment, the processor module 110 at least provides a first power VIN to the power converter module 120. The power converter module 120 converts the first power VIN to a second power VLD to drive the backlight module 12 according to a driving parameter set in a plurality of predetermined driving parameter sets.

In the present embodiment, the power converter module 120 includes a first connector 122, and the backlight module 12 includes a second connector 16. The power converter module 120 is electrically connected to the backlight module 12 through the first connector 122 and the second connector 16. A part of pins 123 of the first connector 122 are identification pins, and when the first connector 122 is electrically connected to the second connector 14, identification signals including identification information are generated through the identification pins, so as to identify a configuration of the backlight module 12, where the identification pins 123 are set corresponding to the configuration of the backlight module. Generally, the second connector 16 may have a different design configuration in response to different configuration of the backlight module 12.

In the present embodiment, the processor module 110 or the power converter module 120 determines the configuration of the backlight module 12 according to the identification signals, and selection of the driving parameter set is also adjusted along with different configuration of the backlight module 12. In the present embodiment, taking a light-emitting diode (LED) backlight module as an example, the difference of the configuration of the backlight module includes a difference of the number of LED strings on the backlight module 12, or a difference of the number of LEDs on each of the LED strings. At least in response to the different configuration of the backlight module, the power converter module 120 provides a proper LED driving current or LED driving voltage, or provides a proper current protection mechanism or voltage protection mechanism to the backlight module 12. Therefore, the predetermined driving parameter set at least includes related adjusting parameters of the LED driving current and the LED driving voltage, or includes related adjusting parameters of the current protection mechanism and the voltage protection mechanism.

In an application, the backlight driving module 100 of the present embodiment detects the configuration of the backlight module 12 according to the identification information provided by the identification pins 123 or by using the identification pins 123, such that the backlight driving module 100 can read the configuration of the backlight module 12, and can set or select the driving parameter set in a software, hardware or firmware manner, so as to properly drive the backlight module 12. Therefore, the backlight driving module 100 of the present embodiment has high compatibility, and can simultaneously support different configurations of the backlight module to effectively decrease the cost.

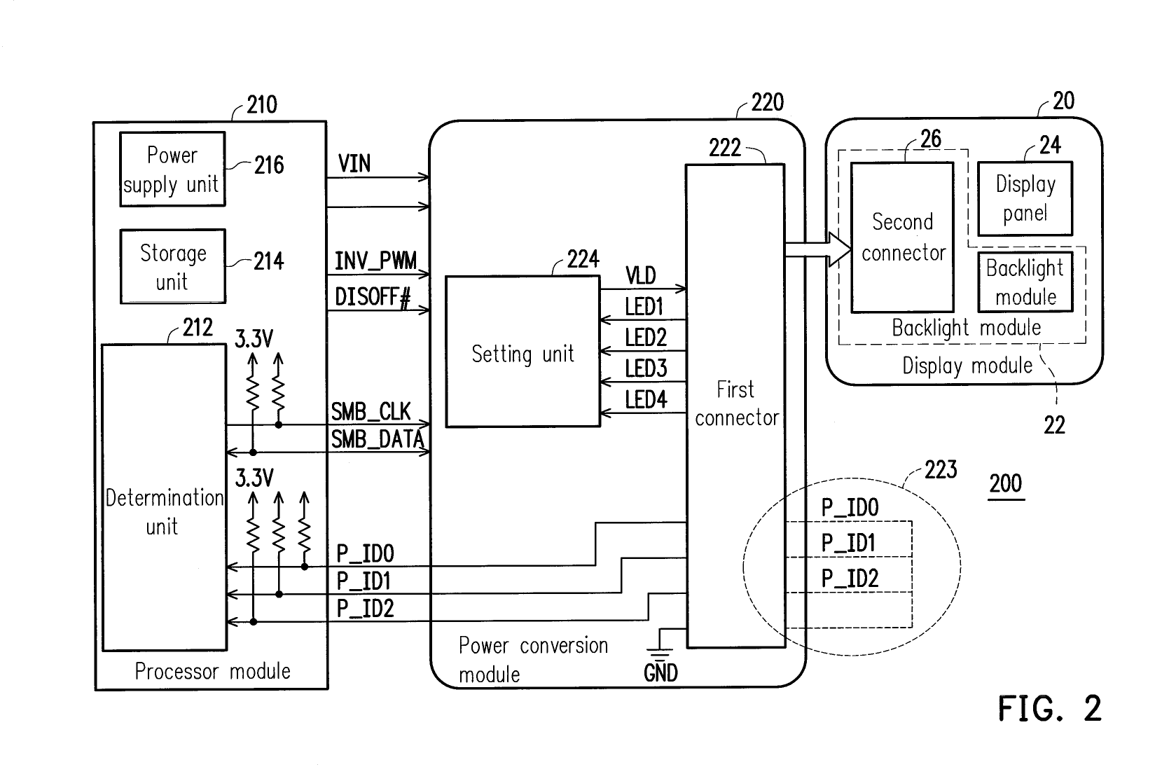

FIG. 2 is a schematic diagram of a backlight driving module according to another embodiment of the disclosure. Referring to FIG. 2, the backlight driving module 200 of the present embodiment includes a processor module 210 and a power converter module 220. The processor module 210 includes a determination unit 212, a storage unit 214 and a power supply unit 216. In the present embodiment, the determination unit 212 is, for example, a central processing unit (CPU) or an embedded controller, which is used for receiving the identification signals P_ID0 to P_ID2 containing the identification information, and determining the configuration of the backlight module 22 according to the identification signals P_ID0 to P_ID2, so as to select one of the driving parameter sets to the power converter module 220.

For example, if the backlight module 22 has a first configuration, in this case, the identification pins 223 are, for example, set to a pattern where a first pin and a second pin thereof are coupled to the ground, and a third pin thereof is not coupled to the ground, such that the corresponding identification signals P_ID0 to P_ID2 can be characterized in form of 001. If the backlight module 22 has a second configuration, in this case, the identification pins 223 are, for example, set to a pattern where the first pin and the third pin thereof are coupled to the ground, and the second pin thereof is not coupled to the ground, such that the corresponding identification signals P_ID0 to P_ID2 can be characterized in form of 010. Therefore, the determination unit 212 can determine whether the backlight module 22 has the first configuration or the second configuration according to the identification signals P_ID0 to P_ID2, so as to select a different driving parameter set for providing to a setting unit 224 of the power converter module 220.

In the present embodiment, a difference between the first configuration and the second configuration, for example, includes a difference of the number of LED strings configured on the backlight module, or a difference of the number of LEDs on each of the LED strings, so that a different driving parameter set is required for driving the backlight module. Moreover, in the present embodiment, although the number of the part of pins the first connector 222 that serve as the identification pins is three, the disclosure is not limited thereto, and the number of the identification pins can be adjusted along with different circuit designs, and the method for characterizing the identification signals can also be varied according to an actual design requirement.

In the present embodiment, the storage unit 214 is used for storing a plurality of predetermined driving parameter sets. The determination unit 212 selects one driving parameter set from the predetermined driving parameter sets stored in the storage unit 214. The storage unit 214 includes a memory, and the memory may store the driving parameter sets corresponding to different configurations of the backlight module in form of a lookup table, such that an efficiency that the determination unit 212 selects and accesses the driving parameter set is improved.

In the present embodiment, the power supply unit 216 is used for providing the first power VIN to the power converter module 220 according to an indication of the determination unit 212. In another embodiment, the power supply unit 216 can be integrated with the determination unit 212. Namely, in another embodiment, the determination unit 212 provides the first power VIN to the power converter module 220.

In the present embodiment, the power converter module 220 includes a setting unit 224. The setting unit 224 is used for at least converting the first power VIN to the second power VLD to drive the backlight module 22 according to the driving parameter set selected by the determination unit 212. Namely, the setting unit 224 provides a proper LED driving current, a LED driving voltage, or a proper current protection mechanism and a voltage protection mechanism to the backlight module 22 according to the configuration of the backlight module 22 based on the received driving parameter set. In the present embodiment, the number of the LED strings of the backlight module 22 is, for example, 4, so that the setting unit 224, for example, drives the LED strings of the backlight module 22 by using driving channels LED1-LED4, and receives a feedback signal from the backlight module 22 to obtain operation information of the backlight module 22, and accordingly performs an adaptive adjustment. The number of the LED strings of the backlight module is not limited by the disclosure.

It should be noticed that in the backlight driving module 200 of the present embodiment, the processor module 210 determines the configuration of the backlight module, and selects the corresponding driving parameter set from the storage unit 214. However, the disclosure is not limited thereto. In another embodiment, the steps of determining the configuration of the backlight module and selecting the driving parameter set can also be implemented by the power converter module 220. In another embodiment, the power converter module includes a storage unit or a register unit to store the predetermined driving parameter sets.

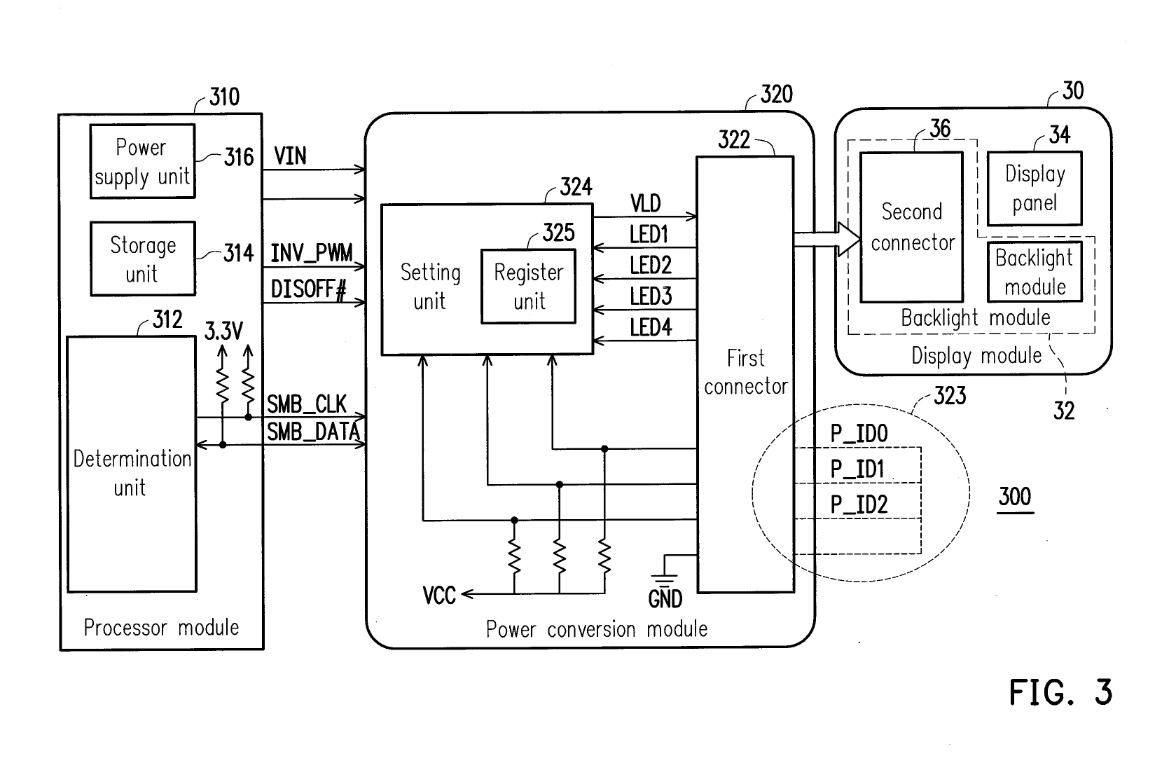

FIG. 3 is a schematic diagram of a backlight driving module according to another embodiment of the disclosure. Referring to FIG. 3, the backlight driving module 300 of the present embodiment is similar to the backlight driving module 200 of the embodiment of FIG. 2, and a main difference there between is that the power converter module 320 can self-determine the configuration of the backlight module 32 according to the identification signals. P_ID0 to P_ID2, and the setting unit 324 of the power converter module 320 includes a register unit 325 for temporarily storing the identification signals P_ID0 to P_ID2. In the present embodiment, the determination unit 312, for example, read the identification signals P_ID0 to P_ID2 stored in the register unit 325 by using a system management bus (SMBus or SMB) or a serial communication bus of an inter-integrated circuit (I²C) form. Moreover, the determination unit 312 compares a plurality of the predetermined driving parameter sets stored in the storage unit 314 according to the identification signals P_ID0 to P_ID2, and transmits the proper driving parameter set to the power converter module 320. In the present embodiment, signals of the system management bus include signals SMB_CLK and SMB_DATA. Moreover, the determination unit 312 can also provide a clock signal INV_PWM required in operation of the power converter module 320 and a disable/enable signal DISOFF# used for controlling actuation of the power converter module 320 to the power converter module 320. The setting unit 324 provides a proper LED driving current, a LED driving voltage, or a proper current protection mechanism and a voltage protection mechanism to the backlight module 32 according to the configuration of the backlight module 32 based on the received driving parameter set.

Along with a different product design, the predetermined driving parameter sets can also be stored in the register unit 325 of the setting unit 324, which is not limited by the disclosure. Therefore, after the setting unit 324 identifies the configuration of the backlight module 32 according to the identification signals P_ID0 to P_ID2, the setting unit 324 can select one of the driving parameter sets stored in the register unit 325 to drive the backlight module 32. In the present embodiment, the driving parameter sets stored in the storage unit 314 can be pre-stored to the register unit 325 to facilitate the setting unit 324 performing comparison after identifying the configuration of the backlight module 32.

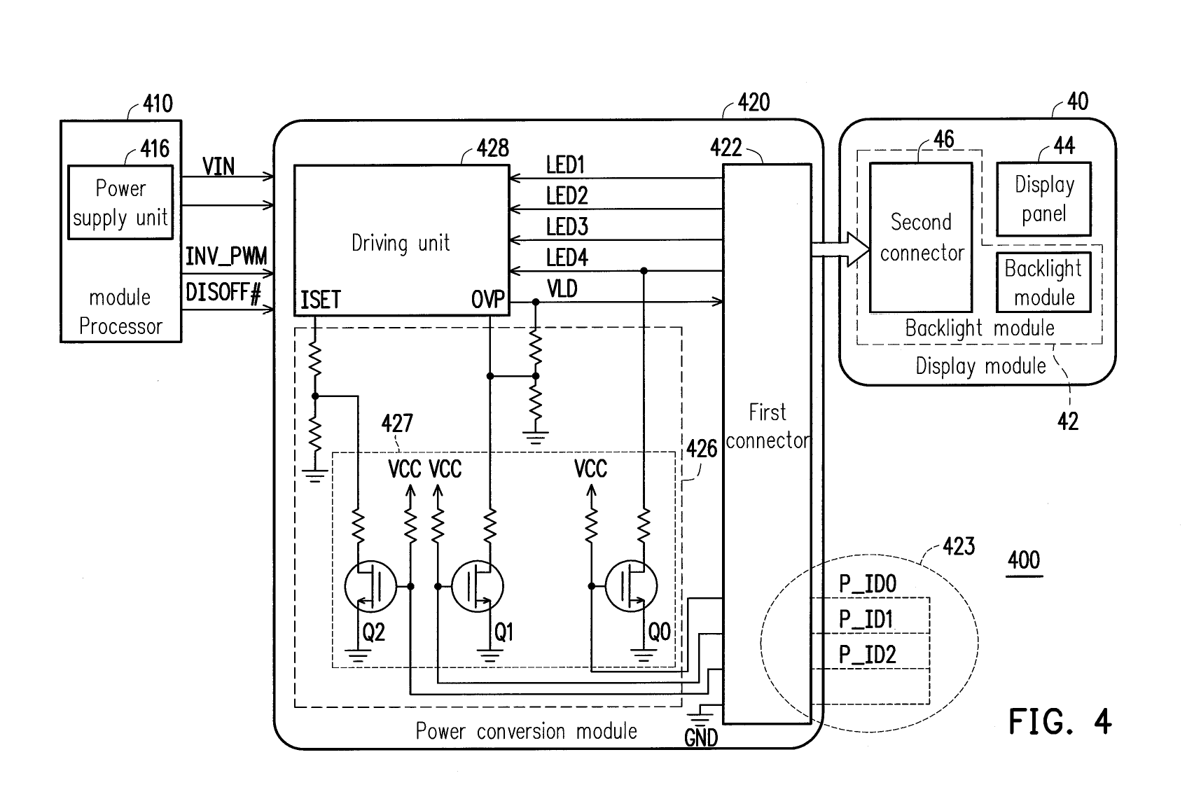

FIG. 4 is a schematic diagram of a backlight module according to another embodiment of the disclosure. Referring to FIG. 4, the determination unit 426 of the present embodiment is disposed in the power converter module 420. In other words, the step of determining the configuration of the backlight module 42 is performed by the power converter module 420 itself.

In detail, in the present embodiment, the power converter module 420 includes a determination unit 426 and a driving unit 428. The determination unit 426 determines the configuration of the backlight module 42 according to the identification signals P_ID0 to P_ID2 including the identification information. In the present embodiment, the determination unit 426 includes a logic circuit 427, and the logic circuit 427 includes switches Q0, Q1 and Q2. In the present embodiment, the switch Q0 is connected to the backlight module through a driving channel LED4. Therefore, the driving channel LED 4 can be turned on/off under control of the identification signal P_ID0, so as to turn off the unnecessary driving channel in response to the configuration of the backlight module 42. For example, when the identification signal P_ID0 is set to 1, the switch Q0 is turned on, and the driving channel LED4 is connected to the ground and is turned off. Similarly, the driving channels LED1-LED3 can be controlled to turn on/off. Therefore, in other embodiments, according to an actual design requirement, a plurality of switches can be added to the logic circuit 427 for respectively coupling to the driving channels LED1-LED3, so as to control conduction states of the driving channels LED1-LED3. In other words, in other embodiments, the logic circuit includes a plurality of switches. Any of the switches is connected to the backlight module through one driving channel. The identification information can be used to control a conduction state of the driving channel through a plurality of the switches, so as to generate the driving parameter set to drive the backlight module. It should be noticed that the number of the switches and the number of the driving channels of the present embodiments are not limited by the disclosure. Moreover, in the present embodiment, the identification signal P_ID1 is used for controlling the switch Q1, so as to control the driving unit 428 to provide different over voltage protection (OVP) functions according to the configuration of the backlight module 42. The identification signal P_ID2 is used for controlling the switch Q2, so as to control the driving unit 428 to provide different driving currents.

In the present embodiment, the driving unit 428 generates the driving parameter set according to a determination result of the determination unit 426. Then, the driving unit 428 converts the first power VIN to the second power VLD according to the generated driving parameter set, so as to drive the backlight module 42.

Therefore, in the present embodiment, the identification pins 423 are set corresponding to the configuration of the backlight module, and can be used to control the actuation of the logic circuit 427, such that the driving unit 428 converts the first power VIN to the second power VLD according to the configuration of the backlight module, and provides a proper driving parameter set to drive the backlight module 42.

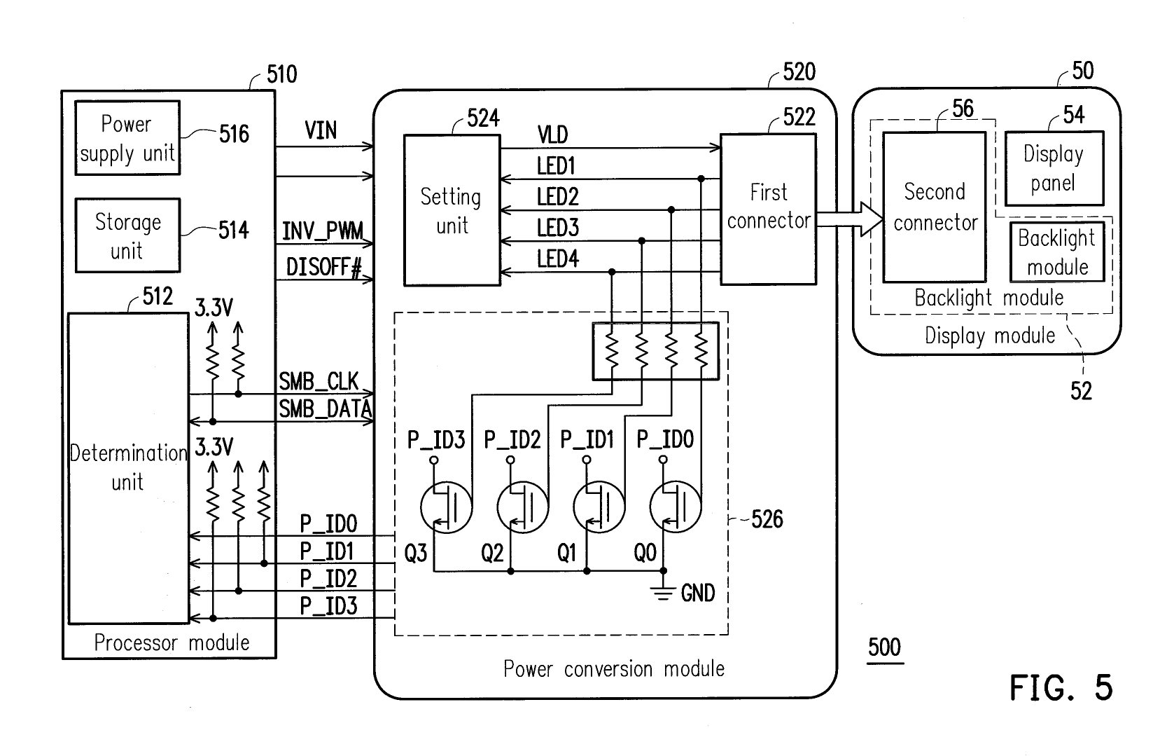

FIG. 5 is a schematic diagram of a backlight driving module according to another embodiment of the disclosure. Referring to FIG. 5, the backlight driving module 500 of the present embodiment is similar to the backlight driving module 200 of the embodiment of FIG. 2, and a difference there between is that the power converter module 520 includes a detection unit 526, which is used for detecting the configuration of the backlight module 52 for providing the identification signals P_ID0 to P_ID3 including the identification information to the processor module 510.

In detail, in the backlight driving module 500 of the present embodiment, the power converter module 520 first sends a detection signal to the backlight module 52, for example, the second power VLD can be directly used as the detection signal to light up the LED strings on the backlight module 52. Then, the backlight module 52 sends feedback signals P_ID0 to P_ID3 to the determination unit 512 to serve as the identification information through the first connector 522, the second connector 56, and the detection unit 526. For example, if the backlight module 52 includes three LED strings, three of the driving channels LED1-LED4, for example, the driving channels LED1-LED3 transmit high level voltage signals to turn on the switches Q1-Q3. Now, the feedback signals P_ID0 to P_ID2 can be characterized in form of 000, such that the determination unit 512 can determine the configuration of the backlight module 52 to select the proper driving parameter set. Similarly, by characterizing the feedback signals P_ID0 to P_ID3, the determination unit 512 can determine the number of the LED strings configured to the backlight module 52 electrically connected to the backlight driving module 500, for example, one to four. Therefore, in the present embodiment, the power converter module 520 can actively send a detection signal (for example, a power signal) to detect the configuration of the backlight module 52 by itself, and provide the feedback signals P_ID0 to P_ID3 to the determination unit 512 for determination, so as to select the proper driving parameter set and provide the same to the setting unit 524 of the power converter module 520.

It should be noticed that the number of the LED channels LED1-LED4 and the number of the feedback signals P_ID0-P_ID3 of the present embodiment are not limited by the disclosure.

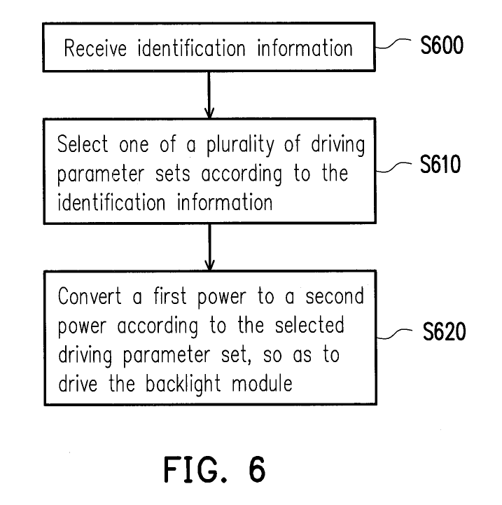

FIG. 6 is a flowchart illustrating steps of a driving method of a backlight module according to an embodiment of the disclosure. Referring to FIG. 2 and FIG. 6, the driving method of the backlight module of the present embodiment is, for example, adapted to the backlight driving module 200 of FIG. 2, and the driving method includes following steps. In step S600, the processor module 210 receives the identification signals P_ID0 to P_ID2 including the identification information, where a part of pins of the first connector 222 are set corresponding to the configuration of the backlight module 22 for providing the identification signals P_ID0 to P_ID2 including the identification information. Then, in step S610, one of a plurality of driving parameter sets stored in the storage unit 214 is selected according to the identification information, where the driving parameter set is selected according to the configuration of the backlight module 22. In step S620, the power converter module 220 converts a first power to a second power according to the selected driving parameter set, so as to drive the backlight module 22. In the present embodiment, a part of pins of the first connector 222 are set corresponding to the configuration of the backlight module 22, so as to provide the identification information.

In another embodiment of the disclosure, the driving method further includes detecting the configuration of the backlight module, so as to provide the identification information to the processor module for determination.

Moreover, since those skilled in the art can learn enough instructions and recommendations of the driving method of the backlight module of the present embodiment from descriptions of the embodiments of FIG. 1 to FIG. 5, detailed description thereof is not repeated.

In summary, in the exemplary embodiments of the disclosure, the backlight driving module can select a proper driving parameter set from a plurality of driving parameter set according to a different configuration of the backlight module of the display panel, or self-detect or determine the configuration of the backlight module to generate the driving parameter set, so as to drive the backlight module of the display panel. One of the methods for identifying the configuration of the backlight module is that a part of pins of the connector of the backlight driving module provide the identification information, and the processor module or the power converter module determines the configuration of the backlight module according to the identification information, so as to select the proper driving parameter set. Moreover, in the exemplary embodiment of self-detecting or determining the configuration of the backlight module, the power converter module can actively send a detection signal to the backlight module, and takes a feedback signal as the identification information to generate the driving parameter set. Therefore, the backlight driving module of the exemplary embodiment of the disclosure has high compatibility, and can simultaneously support different configurations of the backlight module to effectively decrease the cost.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A backlight driving module, adapted to a backlight module, the backlight driving module comprising:
a power converter module, configured to convert a first power to a second power to drive the backlight module according to a driving parameter set; and
a processor module, configured to provide the first power to the power converter module,
wherein one of the processor module and the power converter module determines a configuration of the backlight module by using identification information, and the driving parameter set corresponds to the configuration of the backlight module.

2. The backlight driving module as claimed in claim 1, wherein the power converter module comprises a first connector, and the backlight module comprises a second connector, the power converter module is electrically connected to the backlight module through the first connector and the second connector, and a part of pins of the first connector are set corresponding to the configuration of the backlight module for providing the identification information.

3. The backlight driving module as claimed in claim 1, wherein the processor module comprises a determination unit, the determination unit determines the configuration of the backlight module according to the identification information, so as to select the driving parameter set from a plurality of predetermined driving parameter sets, wherein the predetermined driving parameter sets are stored in the processor module or the power converter module.

4. The backlight driving module as claimed in claim 3, wherein the processor module comprises a storage unit, the storage unit stores the predetermined driving parameter sets, and the determination unit selects the driving parameter set from the predetermined driving parameter sets stored in the storage unit.

5. The backlight driving module as claimed in claim 1, wherein the power converter module comprises a setting unit, the setting unit at least converts the first power to the second power to drive the backlight module according to the driving parameter set.

6. The backlight driving module as claimed in claim 5, wherein the setting unit comprises a register unit, the register unit temporarily stores the identification information, and the processor module reads the identification information, and obtains the driving parameter set from the predetermined driving parameter sets stored in the processor module according to the identification information, and the setting unit at least converts the first power to the second power to drive the backlight module according to the driving parameter set.

7. The backlight driving module as claimed in claim 6, wherein the processor module reads the identification information through a system bus.

8. The backlight driving module as claimed in claim 5, wherein the setting unit comprises a register unit, the register unit stores a plurality of predetermined driving parameter sets, and the setting unit selects the driving parameter set from the predetermined driving parameter sets according to the identification information.

9. The backlight driving module as claimed in claim 1, wherein the power converter module comprises a determination unit, the determination unit determines the configuration of the backlight module according to the identification information, wherein the determination unit comprises a logic circuit.

10. The backlight driving module as claimed in claim 9, wherein the logic circuit comprises a plurality of switches, and any one of the switches is connected to the backlight module through a driving channel, wherein the identification information is used for controlling a conduction state of the driving channel to generate the driving parameter set to drive the backlight module.

11. The backlight driving module as claimed in claim 9, wherein the power converter module further comprises a driving unit, the driving unit generates the driving parameter set according to a determination result of the determination unit, and the driving unit at least converts the first power to the second power to drive the backlight module by using the driving parameter set.

12. The backlight driving module as claimed in claim 1, wherein the power converter module comprises a detection unit, the detection unit detects the configuration of the backlight module for providing the identification information to the processor module.

13. The backlight driving module as claimed in claim 10, wherein the detection unit sends a detection signal to the backlight module, and takes a feedback signal as the identification information, and the processor module generates the driving parameter set according to the identification information.
